(19) United States
(12) Patent Application Publication
(10) Pub. No.: US 2018/0374189 A1
(43) Pub. Date: Dec. 27, 2018

(54) POWER EFFICIENT DISPLAY OF REPEATING CONTENT

(71) Applicant: Qualcomm Innovation Center, Inc., San Diego, CA (US)

(72) Inventors: Dileep Marchya, Hyderabad (IN); Rajesh Yadav, Hyderabad (IN)

(21) Appl. No.: 15/703,494

(22) Filed: Sep. 13, 2017

Related U.S. Application Data
(60) Provisional application No. 62/522,953, filed on Jun. 21, 2017.

(51) Int. Cl. G06T 1/60; G06F 1/32; G06F 12/0802

(52) U.S. Cl. CPC G06T 1/60; G06F 1/329; G06F 2212/60; G06F 2212/455; G06F 12/0802

(57) ABSTRACT

A computing device and method for displaying repeating content on the computing device are disclosed. The method includes receiving graphics data from an application and rendering the graphics data, if the graphics data has not been rendered, to produce graphics buffers. The graphics buffers are cached to create a cache of a first draw cycle, and if a current draw cycle is the same as the first draw cycle the cached graphics buffers are retrieved. During composition, graphics buffers are composed into a framebuffer, and the framebuffer is cached to create a cache of a first frame. The framebuffer is then reused if a current frame is the same as the first frame.

### CLAIM OF PRIORITY UNDER 35 U.S.C. § 119

The present Application for Patent claims priority to Provisional Application No. 62/522,953 entitled “POWER EFFICIENT DISPLAY OF REPEATING CONTENT” filed Jun. 21, 2017, and assigned to the assignee hereof and hereby expressly incorporated by reference herein.

### BACKGROUND

### Field

The present invention relates to computing devices. In particular, but not by way of limitation, the present invention relates to apparatus and methods for improving power utilization in connection with displaying content on computing devices.

### Background

Computing devices such as smartphones, netbooks, gaming devices, PDAs, and laptop computers are now ubiquitous. And these devices now very commonly include a display (e.g., touchscreen display) and associated software and hardware that provide a user interface for users to request and view displayed.

With the increasing popularity of messaging and email applications, user input using a keypad is one of the most common activities for a user interaction with the phone. Textbox widgets in these applications typically contain a cursor to indicate current position for user interaction, and the cursor starts blinking as soon as a textbox is presented onto the screen.

For each cursor blink, a processor (e.g., a graphics processing unit (GPU)) of a computing device is interrupted to render the cursor onto the application surface and compose this surface with the rest of the layers onto a framebuffer. A typical cursor blink interval is 500 ms, and a cursor blink is often the only update to the content displayed in a frame, but each time the cursor is updated, the processor is woken up; thus, causing an ongoing draw of power to simply update a cursor. For example, cursor blink may cause substantially more average power consumption than a static screen.

### SUMMARY

According to an aspect, a computing device includes an application configured to produce graphics data for a widget and a graphics library configured to render the graphics data to produce graphics buffers. A window manager is in communication with the application and the graphics library, and the window manager is configured to: receive the graphics data; relay the graphics data to the graphics library to produce the graphics buffers (if the graphics data has not been rendered by the graphics library); and cache the graphics buffers to create a cache of a first draw cycle for the widget. The cached graphics buffers are reused if a current draw cycle for the widget is the same as the first draw cycle to avoid rendering graphics data of the current draw cycle. The computing device also includes a compositor configured to assemble the graphics buffers for a layer along with graphics buffers for other layers for display as a frame of content, and a composer is configured to compose the assembled graphics buffers into a framebuffer to display the frame of content on the computing device. The composer is also configured to cache the framebuffer to create a cache of a previous frame; and reuse the framebuffer if a current frame is the same as the previous frame.

According to another aspect, a method for displaying repeating content on a computing device includes receiving graphics data from an application; rendering the graphics data (if the graphics data has not been rendered) to produce graphics buffers; and caching the graphics buffers to create a cache of a first draw cycle. The cached graphics buffers are retrieved if a current draw cycle is the same as the first draw cycle, and the graphics buffers are composed into a framebuffer. The framebuffer is then cached to create a cache of a first frame; and the framebuffer is reused if a current frame is the same as the first frame.

### BRIEF DESCRIPTION OF THE DRAWINGS

FIG. 1 is a block diagram depicting a computing device according to aspects of the present invention;

FIG. 2 is a diagram depicting displayed content on a computing device;

FIG. 3 is a graph depicting power characteristics of prior art computing devices;

FIG. 4 is a graph depicting power characteristics that are consistent with computing devices disclosed herein;

FIG. 5 is a flowchart depicting aspects of a method that may traversed by computing devices disclosed herein;

FIG. 6 is another flowchart depicting a variation of the method of FIG. 5;

FIG. 7A is a call flow diagram depicting aspects of a call flow of embodiments disclosed herein;

FIG. 7B is another call flow diagram depicting aspects of a call flow of embodiments disclosed herein;

FIG. 8 is another flowchart depicting another variation of the method of FIG. 5 that may be traversed by computing devices disclosed herein;

FIG. 9A is a call flow diagram depicting aspects of a call flow of embodiments disclosed herein;

FIG. 9B is another call flow diagram depicting aspects of a call flow of embodiments disclosed herein; and

FIG. 10 is a block diagram depicting physical components of an exemplary computing device.

### DETAILED DESCRIPTION

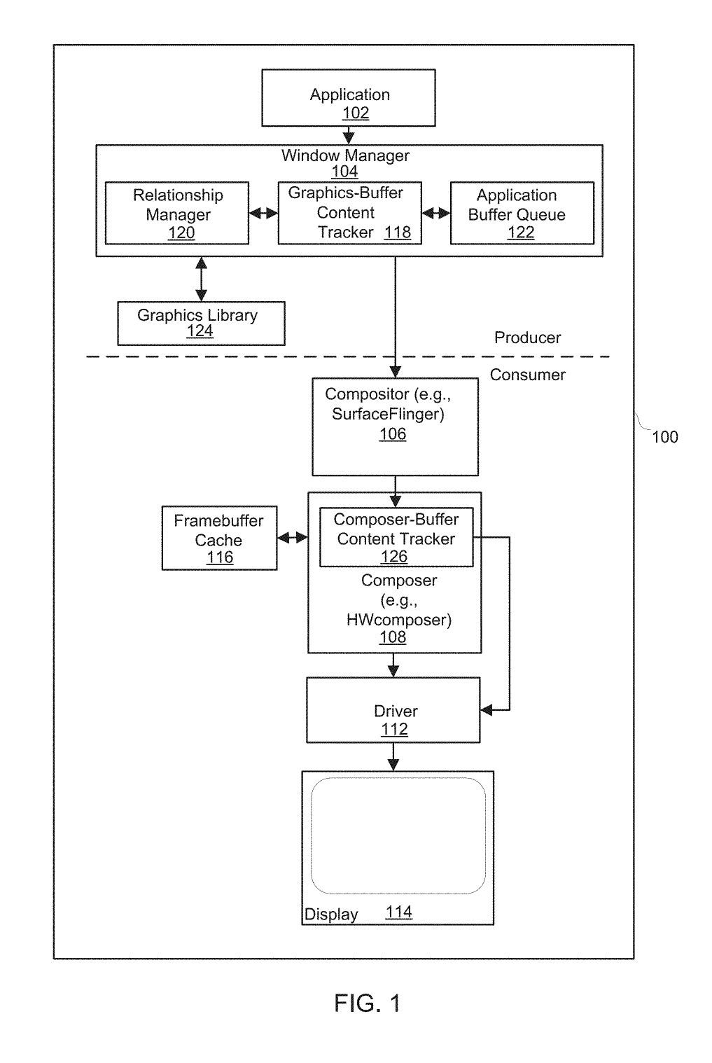

Referring first to FIG. 1, it is a block diagram depicting an embodiment of an exemplary computing device 100. As discussed further herein, the exemplary computing device 100 provides an improved user experience and/or reduced power consumption by reducing processor usage and power usage associated with display updates. In some embodiments for example, once a framebuffer is rendered, the framebuffer is reused; thus, eliminating the need for power-intensive rendering and composition.

The use cases where this aspect of reusing rendered buffers is beneficial are those use cases that may generally be characterized as including the repetition of displayed content where rendering the same repeating content draws a substantial amount of power. As an example, many applications (also referred to as apps) utilize a widget to display a flashing pointer so a user is informed about a location in the display where they may alter the displayed content.

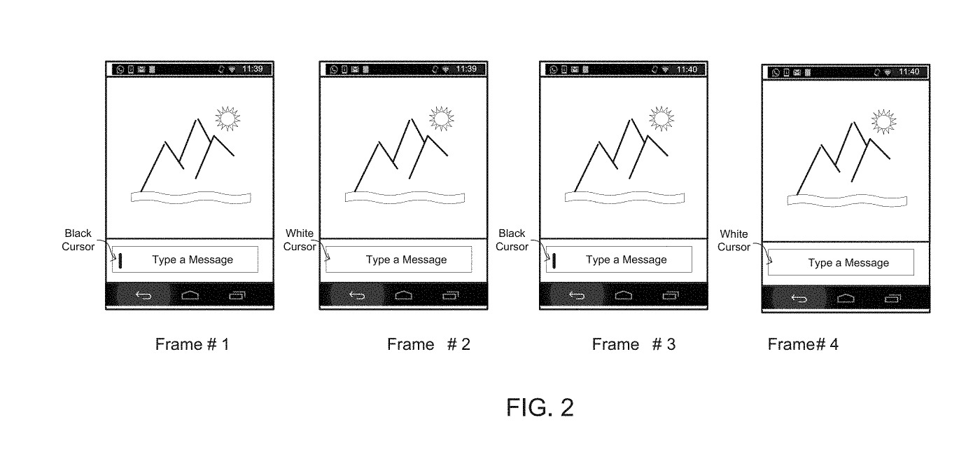

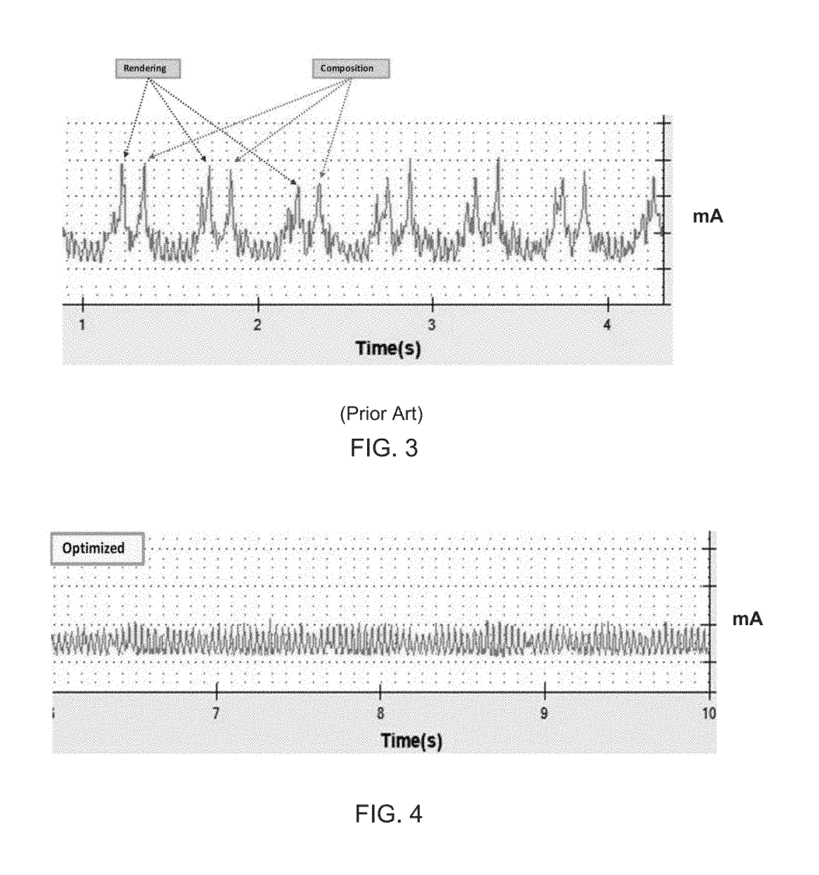

Referring to FIG. 2 for example, several frames are shown in which a pointer (e.g., a cursor) is displayed as either black or white in alternating frames. In prior implementations, for each cursor blink, processing resources (e.g., a GPU and or display processor) were utilized to render the cursor onto the application surface and compose the surface with other layers onto a framebuffer. As shown in FIG. 3, both the rendering and composition of the drawn curser causes corresponding increases in current, and hence, increases in the level of power drawn by the processing resources. In contrast, when a previously rendered buffer is reused for a collection of frames such as those depicted in FIG. 2, the steady state current draw (e.g., after the initial rendering of the first two frames) is consistent with the current draw depicted in FIG. 4, which does not include the spikes in current draw associated with repetitive rendering and composition.

Referring back to FIG. 1, the computing device 100 includes an application 102 in communication with a window manager 104, and the window manager 104 is in communication with a compositor 106 that is in communication with a composer 108. In addition, a driver 112 is coupled both to the composer 108 and a display 114, and the composer 108 is also in communication with a framebuffer cache 116. As shown, the window manager 104 includes a graphics-buffer content tracker 118, a relationship manager 120, and an application buffer queue 122, and the window manager 104 is in communication with a graphics library 124. Also shown in FIG. 1 is a composer-buffer content tracker 126, which is in communication with the compositor 106, the composer 108, the driver 112, and the framebuffer cache 116.

The depiction of these components is logical and is not necessarily intended to be a depiction of discrete components. For example, the division of the relationship manager 120 and the graphics-buffer content tracker 118 in FIG. 1 is intended to convey different functions, but it is contemplated that these constructs may be combined into an integrated construct or further separated into constituent components. Moreover, the components may be realized by hardware, software in connection with hardware, firmware, or a combination thereof. And although not required, the relationship manager 120, graphics-buffer content tracker 118, and the composer-buffer content tracker 126 may be realized by additions and modifications readily apparent to one of ordinary skill in the art (in light of this disclosure) to existing computing devices. For example, the embodiment depicted in FIG. 1 may be realized by modifying user-level and kernel level components of an ANDROID-based computing device.

The computing device 100 may be realized by a variety of devices such as smartphones, netbooks, gaming devices, PDAs, tablets, and laptop computers. The application 102 is an example of a variety of different types of producers of graphics data that a user may view or interact with to request, retrieve and view content such as a web browser, messaging app, email app, or any of a variety of other applications that utilize displayed content (e.g., gaming, utility, and educational apps), which changes in a repeating manner.

The window manager 104 generally functions to manage a z-ordered list of visible windows and manage how the windows are laid out on the display 114. Among other things, it automatically performs window transitions and animations when opening or closing an app or rotating the screen. A Z-order is an ordering of overlapping two-dimensional objects, such as windows in the window manager, or objects in a 3D application. As one of ordinary skill in the art will appreciate windows may overlap, so that one window hides part or all of another.

The compositor 106 generally manages multiple surfaces from the application 102 and various other apps. Although not required, the compositor 106 may be realized by the SurfaceFlinger module (or a derivative of the SurfaceFlinger module) of the ANDROID framework. In operation, for example, there may be many running applications with independent surfaces that are being rendered. The compositor 106 determines what will be shown on the display 114 and provides overlays as needed. An aspect of the role of the compositor 106 is to accept buffers of data from multiple sources (e.g., the application 102) and composite them for later display.

When an app comes to the foreground (e.g., because the user selects the app or an event (e.g., a text message being received) prompts the app to the foreground), the compositor 106 creates a “layer.” For example, there are commonly three or more layers on the display 114 at any time: a status layer at the top of the screen, a navigation layer at the bottom or side, and application's user interface. Some apps may have more or less layers, and each layer can be updated independently.

As discussed in more detail further herein, the relationship manager 120 generally operates to attach relationship data to a graphics buffer (also referred to herein as a buffer) to indicate a relationship between a current buffer and a previous buffer. For example, the relationship may indicate which prior graphics buffers (from a prior draw cycle) are the same as graphics buffers of a current draw cycle. Although not required, the relationship manager 120 may be implemented by augmenting the functionality of an existing window manager. For example, the window manager 104 may be realized by augmenting the functionality of the WindowManager of the ANDROID framework.

The graphics-buffer content tracker 118 generally operates to track the content of the buffers that are relayed to the graphics library 124 so that any previously rendered buffers may be reused. The graphics library 124 operates as an interface to underlying hardware of the computing device such as a graphics processing unit so that, when needed, buffers may be rendered.

The composer 108 in this embodiment operates as a hardware abstraction layer (HAL) that is used by the compositor 106 to perform composition using hardware resources such as a mobile display processor, 3D graphics processing unit (GPU) or a 2D graphics engine (not shown in FIG. 1). In general, the compositor 106 determines how to composite buffers with the available hardware on the computing device. In the context of an ANDROID-based computing device, the composer 108 may be realized using the ANDROID HWcomposer (or a derivative thereof). But in this embodiment, the composer 108 includes a composer-buffer content tracker 126, which operates to track the content layers to determine whether composition of framebuffers may be avoided to save power.

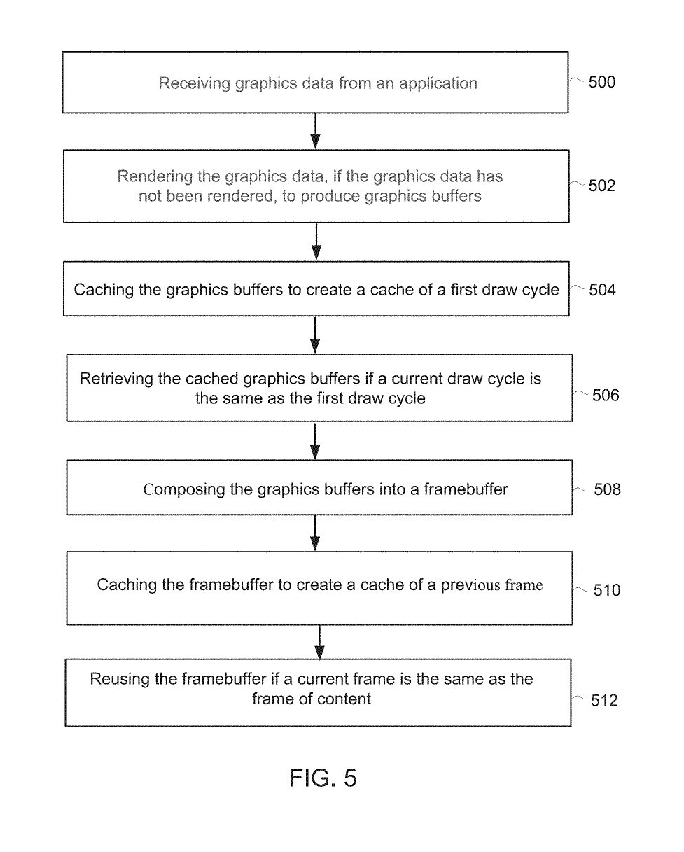

Referring next to FIG. 5, shown is a flowchart depicting a method that may be traversed in connection with the embodiment depicted in FIG. 1. As shown, graphics data is received from the application 102 (e.g., graphics data for a widget) at the window manager 104 (Block 500), and the window manager 104 directs the graphics data to the graphics library 124 (if the graphics data has not yet been rendered) to prompt the graphics library 124 to render the graphics data to produce graphics buffers (Block 502). The graphics buffers are then cached in the application buffer queue 122 to create a cache for a first draw cycle (Block 504). As used in Block 504, the term “first” is merely a reference to a draw cycle that precedes another draw cycle—it is not intended to mean a first ever drawn cycle.

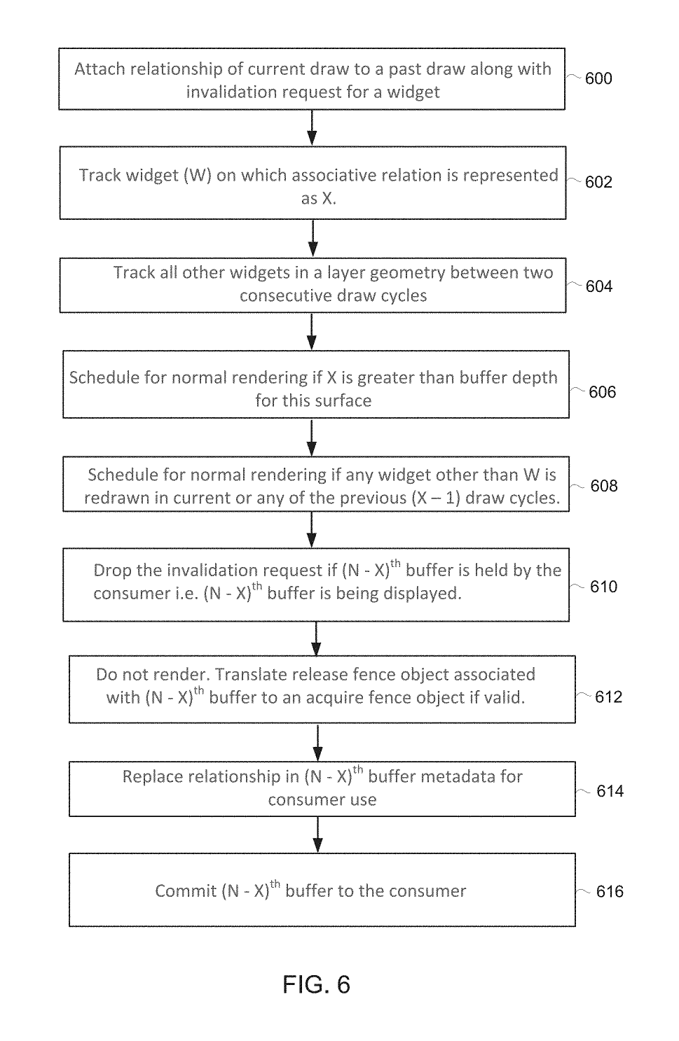

If graphics data of a current draw cycle (occurring subsequent to the first draw cycle) is the same as the graphics data of the first draw cycle, then the cached graphics buffers may be retrieved from the application buffer queue 122 (Block 506). In this way, the cached graphics buffers are reused if a current draw cycle for the layer is the same as the first draw cycle to avoid rendering graphics data of the current draw cycle. As a consequence, use of power-intensive resources (such as a graphics processing unit) may be avoided. As discussed further herein with reference to FIG. 6, there may be several conditions that must be met before the cached graphics buffers are reused.

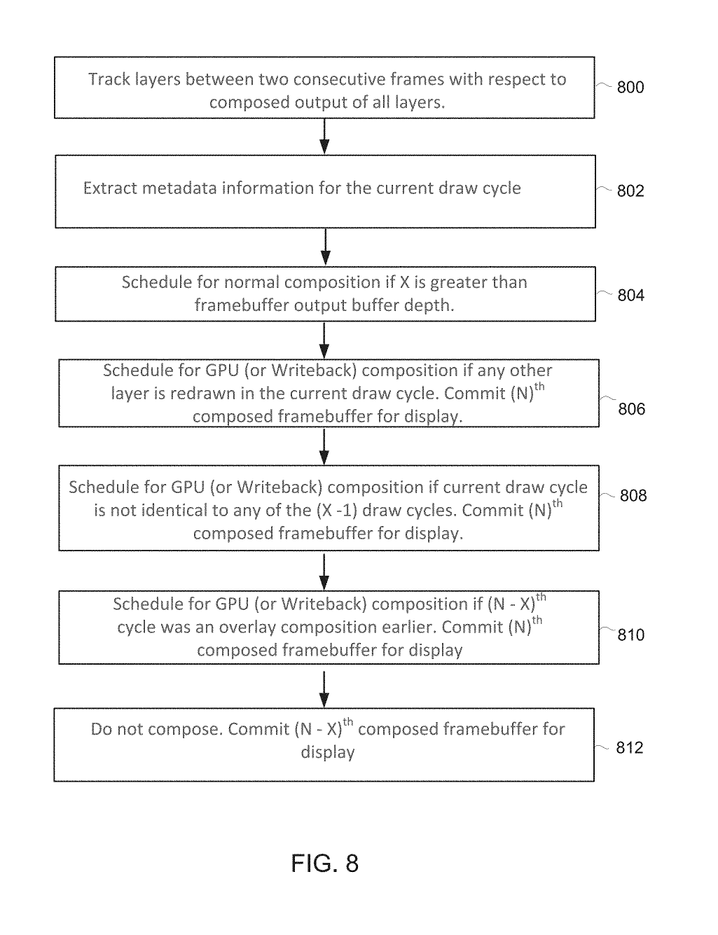

The graphics buffers are then composed into a framebuffer (Block 508). For example, the compositor 106 is configured to assemble the graphics buffers (e.g., for a layer defined by the received graphics data) along with other graphics buffers (e.g., associated with other layers) for display as a frame of content. And the composer 108 is configured to compose the assembled graphics buffers into a framebuffer that is displayed as a first frame of content on the display 114. As shown in FIG, 5, the framebuffer is cached in the framebuffer cache 116 to create a cache for the first frame (Block 510). Again, the use of the term “first” is merely intended to convey that the first frame is occurring prior in time to another subsequent frame. Caching the framebuffer enables the framebuffer to be reused if the current frame is the same as the first frame (Block 512). As discussed further herein with reference to FIG. 8, there may be several conditions that are satisfied before the cached framebuffer is reused and committed for display.

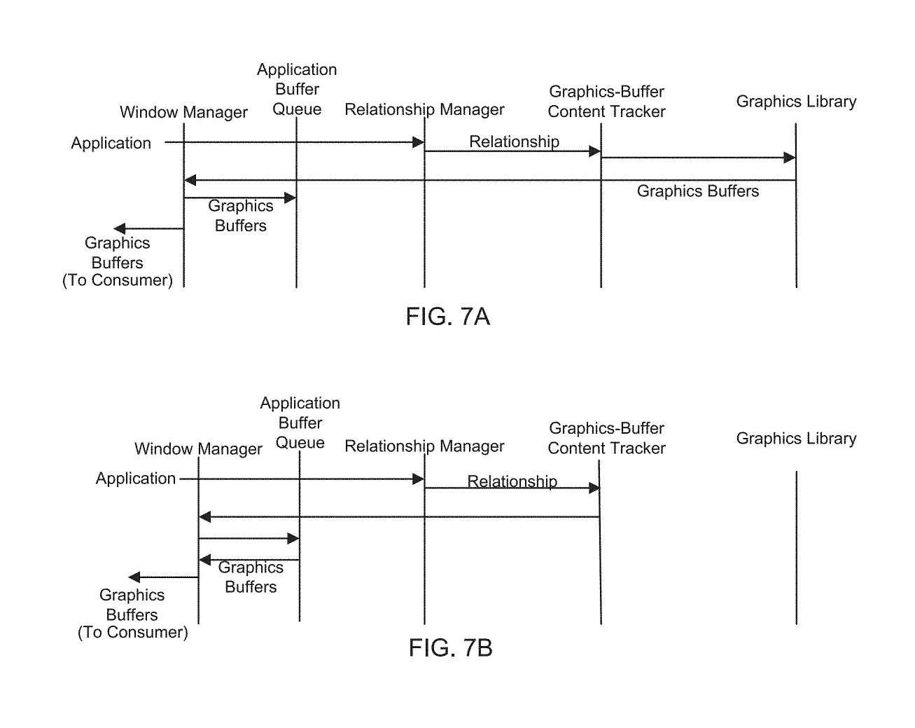

Referring next to FIG. 6, shown is a flowchart depicting a method that may be traversed from a producer side of the computing device 100 in connection with Blocks 500 to 506 of FIG. 5. While referring to FIG. 6, reference is also made to FIGS. 7A and 7B, which depict call flow diagrams that show the call flow between the components depicted in FIG. 1 when the method depicted in FIG. 6 is carried out. As shown, in response to a client (e.g., the application 102) providing graphics data (e.g., for a widget) to the window manager 104, the relationship manager 120 attaches an indication of a relationship of a current draw cycle to a past draw cycle along with an invalidation request (e.g., for the widget)(Block 600). For example, the relationship may be that the current, N^{th} cycle redraw is identical to an (N-X)^{th} cycle redraw for the widget.

The graphics-buffer content tracker 118 then tracks, both, the widget that has the associative relation represented as X (Block 602) and all other widgets in a layer geometry between two consecutive draw cycles (Block 604). The graphics-buffer content tracker 118 will schedule the current draw cycle for normal rendering by the graphics library 124 if either X is greater than a buffer depth for a surface of the current draw cycle (Block 606), or if any other widget other than the widget is redrawn in the current draw cycle or any of the previous (X-1) draw cycles (Block 608). FIG. 7A depicts the graphics-buffer tracker 118 calling the graphics library 124 to perform normal rendering.

The invalidation request is dropped if the (N-X)^{th} draw cycle is held by a consumer (e.g., the (N-X)^{th} buffer is being displayed)(Block 610). If the current draw cycle is not scheduled for normal rendering (Blocks 606 and 608) or the invalidation request is not dropped (Block 610), the current draw cycle is not rendered, and the acquire fence associated with (N-X) is closed and set to “−1” because the buffer is already available for consumption (Block 612). Here, “−1” means that the buffer is already produced. The relationship status forwarded by the graphics-buffer content tracker 118 in the (N-X)^{th} buffer metadata is replaced with the new relationship status for consumer use (Block 614), and the (N-X)^{th} buffer is committed to the consumer (Block 616). In some implementations, the relationship status is forwarded to a display hardware abstraction layer (HAL) by a graphics-buffer content tracker 118 only if the graphics-buffer content tracker 118 indicates that it has avoided rendering, and content of this buffer is identical to the (N-X) cycle. But even if rendering cannot be avoided, the relationship status may still be forwarded to indicate that a current frame is identical to an N-X frame, and the composer-buffer content tracker 126 may use this information as a “hint” to avoid recomposing and instead utilize a cached framebuffer.

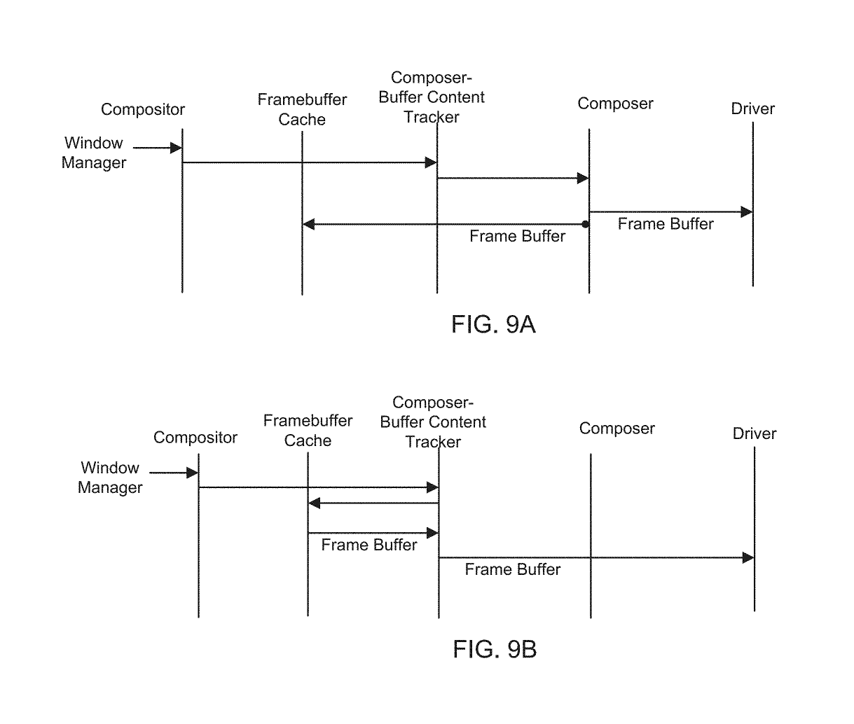

Referring next to FIG. 8, shown is another flowchart depicting logic (associated with the consumer side of the computing device depicted in FIG. 1) for determining whether composition may be avoided. In the implementation depicted in FIG. 1, the composer-buffer content tracker 126 implements the logic depicted in FIG. 8. While referring to FIG. 8, simultaneous reference is made to FIGS. 9A and 9B, which are call flow diagrams depicting the interaction between the components on the consumer side of the computing device 100.

As shown in FIG. 8, the layers of two consecutive frames are tracked with respect to a composed output of all layers (Block 800), and metadata information is extracted from the buffer for the current draw cycle (Block 802). The current draw cycle is scheduled for normal composition (as depicted in FIG. 9A) if X is greater than a framebuffer output buffer depth (Block 804). And the current draw N^{th} cycle is scheduled for GPU (or writeback) composition (and the N^{th} composed framebuffer is committed for display) if any of the following are true: any other layer is redrawn in the current draw cycle (Block 806); the current draw cycle is not identical to any of the X-1 draw cycles (Block 808); the (N-X)^{th} cycle was an overlay composition earlier (Block 810). If none of the conditions set forth above (with reference to Blocks 804-810) are true, the current Nth draw cycle is not scheduled for composition, and instead, the previously composed (N-X)^{th} framebuffer is retrieved from the framebuffer cache 116, and the framebuffer is committed for display (as depicted in FIG. 9B); thus saving power by avoiding the power-intensive composition (e.g., by a memory display processor utilized by the composer 108).

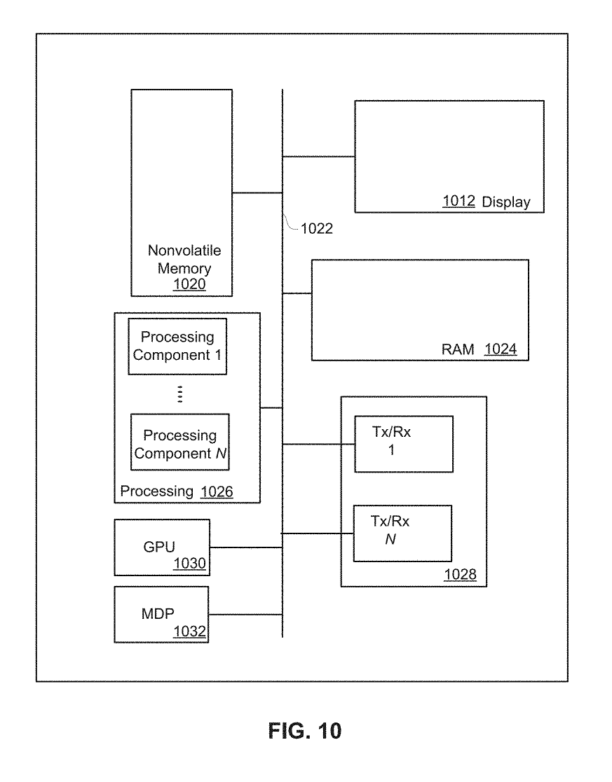

Referring next to FIG. 10, shown is a block diagram depicting physical components that may be utilized to realize one or more aspects of the embodiments disclosed herein. As shown, in this embodiment a display portion 1012 and nonvolatile memory 1020 are coupled to a bus 1022 that is also coupled to random access memory (“RAM”) 1024, a processing portion (which includes N processing components) 1026, a field programmable gate array (FPGA) 1027, and a transceiver component 1028 that includes N transceivers. Although the components depicted in FIG. 10 represent physical components, FIG. 10 is not intended to be a detailed hardware diagram; thus many of the components depicted in FIG. 10 may be realized by common constructs or distributed among additional physical components. Moreover, it is contemplated that other existing and yet-to-be developed physical components and architectures may be utilized to implement the functional components described with reference to FIG. 10.

The display 1012 generally operates to provide a user interface for a user. The display 1012 may be realized, for example, by a liquid crystal display (LCD) or AMOLED display, and in several implementations, the display 1012 is realized by a touchscreen display. The display 1012 may be utilized to realize, at least in part, the display 114 described with reference to FIG. 1 to display webpages (and down sampled versions of webpages while webpages are loading). In general, the nonvolatile memory 1020 is non-transitory memory that functions to store (e.g., persistently store) data and processor executable code (including executable code that is associated with effectuating the methods described herein). In some embodiments for example, the nonvolatile memory 1020 includes bootloader code, operating system code, file system code, and non-transitory processor-executable code to facilitate the execution of functional components depicted in FIG. 1 and the methods described herein including the method described with reference to FIGS. 5, 6, and 8.

In many implementations, the nonvolatile memory 520 is realized by flash memory (e.g., NAND or ONENAND memory), but it is contemplated that other memory types may be utilized as well. Although it may be possible to execute the code from the nonvolatile memory 1020, the executable code in the nonvolatile memory is typically loaded into RAM 1024 and executed by one or more of the N processing components in the processing portion 1026.

The N processing components in connection with RAM 1024 generally operate to execute the instructions stored in nonvolatile memory 1020 to enable the display of graphical content (and the deferred updating of graphical layers). For example, non-transitory processor-executable instructions to effectuate the methods described with reference to FIG. 10 may be persistently stored in nonvolatile memory 1020 and executed by the N processing components in connection with RAM 1024. As one of ordinarily skill in the art will appreciate, the processing portion 1026 may include an application processor (which may include multiple cores), digital signal processor (DSP), and other processing components. Also shown are a graphics processing unit (GPU) 1030 and a mobile display processor 1032. Although not required, in some embodiments, the graphics processing unit 1030 may be utilized by the graphics library 124 to render graphics data, while the mobile display processor 1032 is utilized by the composer 108 during composition of frame buffers into a framebuffer. But it should be recognized that the specific hardware resources that are utilized for rendering and composition (and avoided by the techniques disclosed herein) may vary depending upon the hardware capabilities of the computing device.

In addition, or in the alternative, an FPGA may be configured to effectuate one or more aspects of the methodologies described herein (e.g., the methods described with reference to FIGS. 5, 6, and 8). For example, non-transitory FPGA-configuration-instructions may be persistently stored in nonvolatile memory 1020 and accessed by the FPGA (e.g., during boot up) to configure the FPGA to effectuate functions of one or more of the components depicted in FIG. 1.

The depicted transceiver component 1028 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized to request and receive webpages and send form data as described herein. In many embodiments, the computing device 100 is a wireless computing device that utilizes wireless transceiver technology, but the computing device 100 may also be implemented using wireline technology.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

FIG. 10 depicts an example of constructs that may be utilized to implement embodiments disclosed herein, but the various illustrative logical blocks, modules, and circuits described in connection with the embodiments disclosed herein may be implemented or performed in a variety of different ways. For example, the various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, erasable programmable read-only memory (EPROM) memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
an application configured to produce graphics data for a widget;
a graphics library configured to render the graphics data to produce graphics buffers;
a window manager in communication with the application and the graphics library, the window manager is configured to:
receive the graphics data;
relay the graphics data to the graphics library to produce the graphics buffers if the graphics data has not been rendered by the graphics library;
cache the graphics buffers to create a cache of a first draw cycle for the widget;
reuse the cached graphics buffers if a current draw cycle for the widget is the same as the first draw cycle to avoid rendering graphics data of the current draw cycle; and
a compositor configured to assemble the graphics buffers for a layer along with graphics buffers for other layers for display as a frame of content;
a composer configured to:
compose the assembled graphics buffers into a framebuffer to display the frame of content on the computing device;
cache the framebuffer to create a cache of a previous frame; and
reuse the framebuffer if a current frame is the same as the previous frame.

2. The computing device of claim 1, including a relationship manager configured to attached relationship data to a graphics buffer to indicate which prior graphics buffers are the same as graphics buffers of a current draw cycle.

3. The computing device of claim 2, including a graphics-buffer content tracker configured to track content of the graphics buffers that are relayed to the graphics library.

4. The computing device of claim 1, including a composer-buffer content tracker configured to track layers to determine whether composition of framebuffers may be avoided to save power, wherein a number of frames between the current draw cycle and the first draw cycle is represented by X.

5. The computing device of claim 4, wherein the composer-buffer content tracker is configured to schedule a current draw cycle for composition if X is greater than a framebuffer output buffer depth.

6. The computing device of claim 5, wherein the composer-buffer content tracker is configured to schedule a current draw cycle for graphics processing unit (GPU) or writeback composition if any layer is redrawn in a current draw cycle or if the current draw cycle is not identical to any of X-1 draw cycles.

7. A method for displaying repeating content on a computing device, the method comprising:
receiving graphics data from an application;
rendering the graphics data, if the graphics data has not been rendered, to produce graphics buffers;
caching the graphics buffers to create a cache of a first draw cycle;
retrieving the cached graphics buffers if a current draw cycle is the same as the first draw cycle;
composing the graphics buffers into a framebuffer;
caching the framebuffer to create a cache of a first frame; and
reusing the framebuffer if a current frame is the same as the first frame.

8. The method of claim 7, wherein the graphics data defines a widget of the application, the method comprising:
attaching an indicator of a relationship, X, of the current draw cycle, N, to the first draw cycle to an invalidation request for the widget, wherein X is a number of frames between the current draw cycle N and the first draw cycle.

9. The method of claim 8, including scheduling the current draw cycle for rendering if X is greater than a buffer depth for the current draw cycle.

10. The method of claim 9, including scheduling the current draw cycle for rendering if any other widgets are redrawn in the current draw cycle or any previous X-1 draw cycles.

11. The method of claim 8 including:
tracking layers between two consecutive frames with respect to a composed output of all layers; and
scheduling the current draw cycle for composition if X is greater than a framebuffer output buffer depth.

12. The method of claim 8 including scheduling the current draw cycle for composition if:
any other layer is redrawn in the current draw cycle; the current draw cycle is not identical to any of the X-1 draw cycles; the (N-X)^{th} cycle was an overlay composition earlier;
otherwise, committing the cached framebuffer for display.

13. A non-transitory tangible processor-readable storage medium encoded with instructions for executing a method for displaying repeating content on a computing device, the method comprising:
receiving graphics data from an application;
rendering the graphics data, if the graphics data has not been rendered, to produce graphics buffers;
caching the graphics buffers to create a cache of a first draw cycle;
retrieving the cached graphics buffers if a current draw cycle is the same as the first draw cycle;
composing the graphics buffers into a framebuffer;
caching the framebuffer to create a cache of a first frame; and
reusing the framebuffer if a current frame is the same as the first frame.

14. The non-transitory tangible processor-readable storage medium of claim 13, wherein the graphics data defines a widget of the application, the method comprising:
attaching an indicator of a relationship, X, of the current draw cycle, N, to the first draw cycle to an invalidation request for the widget, wherein X is a number of frames between the current draw cycle N and the first draw cycle.

15. The non-transitory tangible processor-readable storage medium of claim 14, including scheduling the current draw cycle for rendering if X is greater than a buffer depth for the current draw cycle.

16. The non-transitory tangible processor-readable storage medium of claim 15, including scheduling the current draw cycle for rendering if any other widgets are redrawn in the current draw cycle or any previous X-1 draw cycles.

17. The non-transitory tangible processor-readable storage medium of claim 14 including:
tracking layers between two consecutive frames with respect to a composed output of all layers; and
scheduling the current draw cycle for composition if X is greater than a framebuffer output buffer depth.

18. The non-transitory tangible processor-readable storage medium of claim 14 including scheduling the current draw cycle for composition if:
any other layer is redrawn in the current draw cycle; the current draw cycle is not identical to any of the X-1 draw cycles; the (N-X)^{th} cycle was an overlay composition earlier;
otherwise, committing the cached framebuffer for display.
